(19) United States
(12) Patent Application Publication
(10) Pub. No.: US 2026/0252411 A1
(43) Pub. Date: Aug. 27, 2026

(54) Methods And Systems For Processing Source Files For External Processing Services

(71) Applicant: NETAPP, INC., San Jose, CA (US)

(72) Inventor: Kirk Ryan, Liverpool (GB)

(21) Appl. No.: 19/544,285

(22) Filed: Feb. 19, 2026

Related U.S. Application Data
(60) Provisional application No. 63/761,831, filed on Feb. 21, 2025.

(51) Int. Cl. G06F 9/50; G06F 16/13

(52) U.S. Cl. CPC G06F 9/5094; G06F 16/13

(57) ABSTRACT

Methods and systems involve extracting metadata and contents of source files to produce ingestion record files for the source files, which are transmitted to an external processing service to be processed. The extraction of metadata and contents of the source files includes dividing the metadata and contents of a single source file into multiple ingestion record files when the metadata and contents of the single source file exceeds a predetermined size.

### CROSS-REFERENCE TO RELATED APPLICATION(S)

This patent application claims priority under 35 USC § 119 (e) to U.S. Provisional Patent Application Ser. No. 63/761,831, filed on Feb. 21, 2025, the disclosure of which is incorporated herein by reference in its entirety.

### TECHNICAL FIELD

The present disclosure relates to processing data, and more particularly to preprocessing data for external processing services.

### BACKGROUND

Some external processing services, such as generative artificial intelligence (AI) chatbot services, e.g., Microsoft Copilot, may impose a maximum file chunk size requirement for their input files, such as 3.8 megabytes (MB). These input files may be metadata and contents of source files, such as text files, presentation files, video files, audio files and multimedia files. Thus, for complex and large source files, the metadata and contents may exceed the maximum file size chunk requirement, e.g., larger than 3.8 MB.

Currently, in order to meet the maximum file size requirement, the input files are truncated at the maximum file size and any content after the file size limit is simply dismissed. This results in lost content and, in the worst case, incomplete and inaccurate representations of indexed contents into the external processing services, which can result in undesirable output from the external processing services, such as output with greater hallucinations for generative AI chatbot services.

### SUMMARY

Methods and systems involve extracting metadata and contents of source files to produce ingestion record files for the source files, which are transmitted to an external processing service to be processed. The extraction of metadata and contents of the source files includes dividing the metadata and contents of a single source file into multiple ingestion record files when the metadata and contents of the single source file exceeds a predetermined size.

In an embodiment, a method executed by one or more processors comprises selecting a plurality of source files to be processed by an external processing service, extracting metadata and contents of the source files to produce ingestion record files for the source files, including dividing the metadata and contents of a single source file into multiple ingestion record files when the metadata and contents of the single file exceeds a predetermined size, and transmitting the ingestion record files to the external processing service. In some embodiments, the steps of this method are performed when program instructions contained in a non-transitory computer-readable storage medium are executed by one or more processors.

In an embodiment, a system comprises memory and at least one processor configured to select a plurality of source files to be processed by an external processing service, extract metadata and contents of the source files to produce ingestion record files for the source files, including dividing the metadata and contents of a single source file into multiple ingestion record files when the metadata and contents of the single file exceeds a predetermined size, and transmit the ingestion record files to the external processing service.

Other aspects and advantages of embodiments of the present disclosure will become apparent from the following detailed description, taken in conjunction with the accompanying drawings, illustrated by way of example of the principles of the disclosure.

### BRIEF DESCRIPTION OF THE DRAWINGS

The foregoing features and other features will now be described with reference to the drawings of the various aspects of the present disclosure. In the drawings, the same components have the same reference numerals, and similar reference numbers may be used to identify similar elements. The illustrated aspects are intended to illustrate, but not to limit the present disclosure. The drawings include the following figures.

FIG. 1 shows a computing environment in which embodiments of the invention may be implemented.

FIG. 2 shows components of a service connector in accordance with an embodiment of the invention.

FIGS. 3A and 3B illustrate a technique used by an extract worker of the service connector to create multiple input ingestion record files for a source file using extracted metadata and contents of the source file in accordance with an embodiment of the invention.

FIG. 4A illustrates an example of a paragraph-based division technique to split the metadata and contents of a source file into multiple input ingestion record files in accordance with an embodiment of the invention.

FIG. 4B illustrates an example of a sentence-based division technique to split the metadata and contents of a source file into multiple input ingestion record files in accordance with an embodiment of the invention.

FIG. 4C illustrates an example of a word-based division technique to split the metadata and contents of a source file into multiple input ingestion record files in accordance with an embodiment of the invention.

FIG. 4D illustrates an example of a context-based division technique to split the metadata and contents of a source file into multiple input ingestion record files in accordance with an embodiment of the invention.

FIG. 5 is a flow diagram of an extracting process in accordance with an embodiment of the invention.

FIG. 6 illustrates a distributed computing process that may be employed by the service connector in accordance with an embodiment of the invention.

FIG. 7 is a flow diagram of a method in accordance with an embodiment of the invention.

FIG. 8 is a high-level block diagram showing an example of the architecture of a processing system in accordance with an embodiment of the invention.

### DETAILED DESCRIPTION

The following detailed description is directed to systems and methods for preprocessing source files to enable complete content ingestion by external processing services that impose size limitations on input files. As used throughout this disclosure, “external processing services” include enterprise productivity and collaboration ecosystems (e.g., Microsoft 365, Google Workspace, etc.), generative artificial intelligence (AI) services (e.g., Microsoft Copilot, ChatGPT), search indexing services, compliance and governance platforms, and business intelligence systems. External processing services increasingly serve as the foundation for enterprise knowledge management, AI-assisted decision making, and regulatory compliance. However, the effectiveness of external processing services is fundamentally limited by the ability to access and process complete information from source files. When external processing services lack complete information, the consequences can be severe. For example, without complete information, generative AI systems can produce “hallucinations” which are confident but incorrect responses based on incomplete data. Similarly, search systems can fail to return relevant results because content was never indexed, compliance systems cannot detect policy violations in unprocessed portions of documents, and business intelligence tools generate inaccurate insights based on partial data.

A significant technical problem exists in integrating large source files with external processing services that impose strict size limitations. For example, Microsoft Graph imposes a 3.8 megabyte (MB) limit on extracted content (raw text) and a 100 MB limit on source files. Similar constraints exist across various external processing services due to API limitations, network transmission constraints, and processing timeouts. Large source files are commonplace in enterprise environments. For example, technical specifications with detailed diagrams and tables can often span hundreds of megabytes, legal contracts can contain extensive terms and conditions, financial reports can include comprehensive datasets, research documents can contain complete methodologies and findings, and multimedia presentations can combine text, images, and embedded content.

Enterprise storage systems, such as NetApp ONTAP, support file sizes up to 14 terabytes (TB), and even routine business documents frequently exceed 100 MB when documents include high-resolution images, embedded videos, or extensive appendices. When source files exceed size limitations, existing solutions simply truncate content at the size limit, discarding everything beyond that point (often mid-sentence or mid-word). Truncation can result in: (1) complete loss of content beyond the truncation point, (2) corruption of semantic meaning at the truncation boundary, and (3) incomplete knowledge bases that produce inaccurate outputs. Current connector solutions employ truncation, meaning that critical business information remains invisible to AI assistants, search systems, and compliance tools.

In contrast, present embodiments of the present disclosure solve these technical challenges through semantic-aware chunking that intelligently divides large source files into multiple ingestion records while preserving complete content and maintaining compatibility with external processing services. Rather than truncating content, various embodiments use natural semantic boundaries (e.g., paragraph breaks, sentence endings, or word boundaries) to split content into chunks that each comply with size limitations. Each chunk preserves a reference to the original source file, ensuring that the external processing service can correctly associate all chunks with the source file for proper search result presentation, compliance policy application, and user navigation.

Some embodiments can employ a three-tier hierarchical approach: first attempting to chunk at paragraph boundaries (preserving complete semantic units), falling back to sentence boundaries (maintaining grammatical completeness), and finally using word boundaries (ensuring minimum integrity). Semantic awareness ensures that each chunk contains the most coherent content possible, dramatically improving how external processing services interpret, index, and utilize the information compared to arbitrary byte-position splitting.

In addition, some embodiments incorporate performance optimization techniques that enable efficient processing of large-scale enterprise file systems. For example, parallel computing strategies can be used to overcome single-threaded processing limitations, distributed computing architectures can be used to scale-out processing across multiple nodes, and dynamic worker pool scaling based on computational resources, power costs, or processing demand can be used in various embodiments. These performance enhancements are particularly valuable during initial crawls of large file repositories containing millions of files.

The disclosed techniques enable complete content ingestion from enterprise document repositories into external processing services. As a result, generative AI assistants can access complete document content rather than truncated fragments, reducing hallucinations. Search systems can index entire files, ensuring complete discoverability. Compliance systems can apply policies across complete documents, meeting regulatory requirements. Various embodiments bridge the gap between enterprise-scale storage systems and external processing services with size constraints.

Various embodiments of the present technology provide for a wide range of technical effects, advantages, and/or improvements to computing systems and components. For example, various embodiments may include one or more of the following technical effects, advantages, and/or improvements: 1) non-routine and unconventional implementation of semantic-aware content division that identifies natural linguistic boundaries (e.g., paragraph, sentence, word) to preserve complete source file content across multiple ingestion records while maintaining source references for external processing service compatibility; 2) non-routine and unconventional operations employing a hierarchical fallback mechanism that dynamically evaluates paragraph boundaries first, sentence boundaries second, and word boundaries as a final measure to ensure maximum semantic integrity within size constraints; 3) dynamic processing of large-scale file repositories through parallel computing architectures that distribute extraction tasks across worker pools and dynamically scale worker resources based on computational availability and cost parameters; 4) distributed storage systems with unconventional components configured to interface between enterprise-scale storage systems supporting large files (e.g., up to 14 terabytes) and external processing services with size limitations, including scanners, indexers, extract workers, and controllers that create multiple ingestion records from single source files while preserving compatibility references; 5) technical improvements to generative AI system accuracy by ensuring complete content availability, reducing hallucinations caused by incomplete knowledge bases; 6) technical improvements to search indexing systems by enabling complete document indexing regardless of source file size, ensuring discoverability of content that would conventionally be truncated; 7) technical improvements to compliance and governance systems by enabling policy application across complete document content rather than only portions fitting within size limitations; 8) unconventional metadata extraction creating multiple related ingestion records from single source files, wherein each record includes content portions and metadata linking to the original source file for unified logical document treatment; and/or 9) technical solutions to computer network and data processing limitations by enabling efficient transmission and processing of large file content through size-compliant chunked representations, overcoming API limitations, network transmission constraints, and processing timeout restrictions.

Moreover, the disclosed techniques provide technical effects beyond the normal physical interactions between software and hardware. Specifically, the semantic-aware chunking produces technical effects in the functioning of the computer system itself by: (a) enabling processing of data that would otherwise be rejected or truncated by external systems, thereby expanding the operational capability of the computer network; (b) reducing computational waste by eliminating repeated failed transmission attempts of oversized files; (c) improving data transmission efficiency across network infrastructure by conforming data to transport constraints while preserving completeness; and (d) enhancing the technical functioning of downstream AI, search, and compliance systems by providing complete, semantically coherent data rather than corrupted or incomplete fragments. These technical effects are objective, measurable improvements to computer system functionality rather than mere automation of abstract processes.

As preliminary note, the terms “component”, “module”, “system,” and the like as used herein are intended to refer to a computer-related entity, either software-executing general-purpose processor, hardware, firmware and a combination thereof. For example, a component may be, but is not limited to being, a process running on a processor, a hardware-based processor, an object, an executable, a thread of execution, a program, and/or a computer.

By way of illustration, both an application running on a server and the server can be a component. One or more components may reside within a process and/or thread of execution, and a component may be localized on one computer and/or distributed between two or more computers. Also, these components can be executed from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal).

Computer executable components can be stored, for example, at non-transitory, computer readable media including, but not limited to, an ASIC (application specific integrated circuit), CD (compact disc), DVD (digital video disk), ROM (read only memory), solid state drive, hard disk, EEPROM (electrically erasable programmable read only memory), non-volatile memory or any other storage device, in accordance with the claimed subject matter.

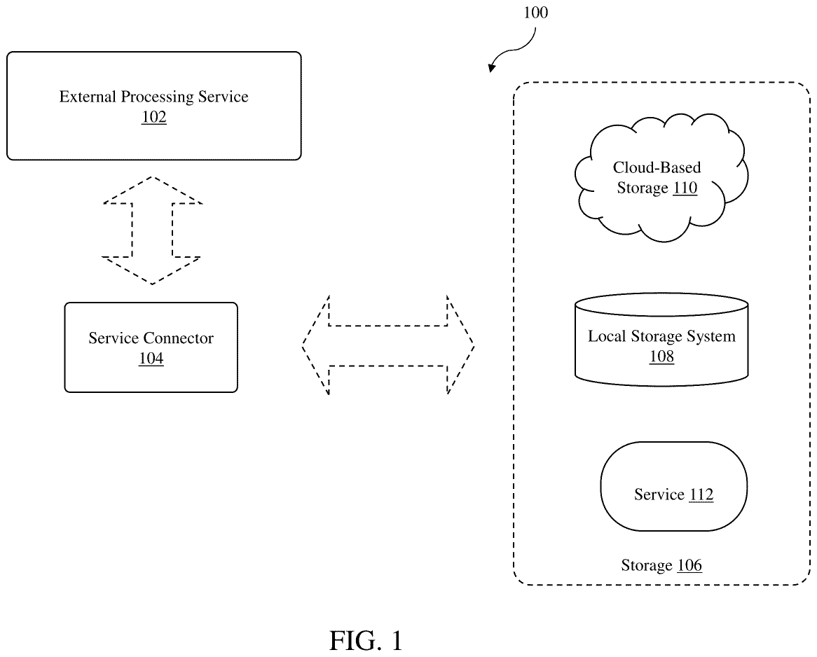

Turning now to FIG. 1, a computing environment 100 in which embodiments of the invention may be implemented is illustrated. As shown in FIG. 1, the computing environment 100 includes an external processing service 102, which may be a web-based or cloud-based service. The external processing service 102 can be any service that ingests data and processes the data to provide information extracted from the data. As an example, the external processing service 102 may be a generative artificial intelligence (AI) chatbot service, such as the Microsoft Copilot service, which can directly or indirectly (e.g., via another service, such as the Microsoft Graph service) ingest the ingestion record files for source files to be used for providing responses to user requests. The source files can be any type of files, such as text files, presentation files, video files and audio files. The ingestion record files of the source files include textual information of contents in the source files, which may include texts in the source files, descriptions of graphics in the source files, description of video content in the source files and transcription of audio content in the source files. In addition to the information contained in the source files, the ingestion record files may also include information regarding the source files, such as the names and locations of the source files.

The external processing service 102 may impose a maximum file size requirement for the input ingestion record files of source files. As an example, the maximum file size requirement for the ingestion record files of source files may be 3.8 MB. Thus, the external processing service 102 may not accept any ingestion record file that exceeds the maximum file size. Consequently, the ingestion record files submitted to the external processing service should be properly sized to ensure that the ingestion record files are not larger than the maximum file size.

The computing environment 100 further includes a service connector 104 and storage 106. The service connector 104 operates to provide authentication, management and file operations required to synchronize file information from the storage 106 to the external processing service 102. In order to synchronize the file information, the service connector 104 operates to process the source files from the storage 106 to generate the corresponding ingestion record files, which are submitted to the external processing service 102. The ingestion record files of source files that are generated by the service connector 104 are customized with respect to content and structure to satisfy the requirements of the external processing service 102. Thus, the ingestion record files of source files that are created by the service connector 104 can vary depending on the particular external processing service with which the service connector is interfacing.

As noted above, one of the requirements of the external processing service 102 may be a maximum file size for input ingestion record files of source files, which may be used to synchronize file information from the storage 106 to the external processing service. As an example, the maximum file size for the input ingestion record files of source files may be 3.8 megabytes (MB). The source files can be any type of files, such as text files, presentation files, video files, audio files and multimedia files, which may include significant amount of content. Thus, for complex and large source files, the metadata and contents may exceed the maximum file size requirement, e.g., larger than 3.8 MB. As explained in more detail below, the service connector 104 is able to transmit the complete metadata and contents of source files, even when the metadata and contents exceeds the maximum file size limit, by splitting or dividing the metadata and contents of source files into multiple input ingestion record files and then submitting the multiple input ingestion record files to the external processing service 102.

Unlike conventional connector solutions that address size limitations through truncation (e.g., discarding content beyond the maximum file size, often breaking content mid-sentence or mid-word, resulting in incomplete data and corrupted semantic meaning at truncation boundaries), various embodiments of the service connector 104 employ semantic-aware chunking techniques (e.g., content division based on linguistic structure and meaning rather than arbitrary size-based splitting) to preserve complete content while complying with size limitations imposed by external processing services. The service connector 104 divides large source files (e.g., files containing extracted metadata and content exceeding the maximum file size requirement) into multiple ingestion records based on natural semantic boundaries (e.g., division points that preserve contextual meaning and linguistic coherence, such as paragraph boundaries that maintain topical units, sentence boundaries that preserve grammatical completeness, or word boundaries that ensure minimum lexical integrity) rather than arbitrary byte positions (e.g., fixed character counts or memory addresses that disregard content structure).

Each ingestion record can include a portion of the extracted content and preserves a reference to the originating source file (e.g., source file identifiers, file paths, uniform resource locators (URLs), or metadata linking structures), enabling the external processing service 102 to correctly associate all ingestion records with their source for proper search result presentation, compliance policy application (e.g., applying data governance rules, retention policies, or regulatory requirements to complete documents), and user navigation (e.g., enabling users to access the original source file from processed content). This reference preservation maintains compatibility with the upstream and downstream processes of the external processing service 102, ensuring that chunked content behaves as a unified logical document within the service ecosystem rather than as disconnected fragments.

Table 1 below illustrates an example of how a single large source file may be divided into multiple ingestion records, each preserving a reference to the originating source file while complying with size limitations.

TABLE 1
Example Ingestion Records for Large Source File

| Ingestion | Source File | | Record | Chunk |
|---|---|---|---|---|
| Record ID | Reference | Content Portion | Size | Index |
| IR-001-A | File Path: | Paragraphs 1-45 | 3.7 MB | 1 of 3 |
| | <storage_path>/ | (Intro-Section 2.3) | | |
| | document.ext | | | |
| | File ID: <UUID> | | | |
| IR-001-B | File Path: | Paragraphs 46-92 | 3.8 MB | 2 of 3 |
| | <storage_path>/ | (Section 2.4-Section | | |
| | document.ext | 4.1) | | |
| | File ID: <UUID> | | | |
| IR-001-C | File Path: | Paragraphs 93-120 | 2.1 MB | 3 of 3 |
| | <storage_path>/ | (Section 4.1-End) | | |
| | document.ext | | | |
| | File ID: <UUID> | | | |

This semantic-aware approach (e.g., content division that respects linguistic and contextual structure) ensures that each ingestion record contains coherent, interpretable content (i.e., semantically complete units that can be independently processed and understood), dramatically improving the accuracy of downstream processing by generative AI services (e.g., reducing hallucinations and improving response accuracy in chatbot systems such as Microsoft Copilot), search indexing systems (e.g., enabling complete document discoverability and relevance ranking across entire file contents), and compliance platforms (e.g., ensuring complete policy coverage and audit trail integrity for regulatory requirements) compared to truncated or arbitrarily fragmented content (e.g., content split without regard to semantic structure, resulting in incomplete context and degraded processing accuracy). The storage 106 of the computing environment 100 is used to store source files, which may be transmitted to the external processing service 102 in the form ingestion record files via the service connector 104. The storage 106 may include multiple storages, such as one or more local storage systems 108, one or more cloud-based storages 110 and one or more services 112.

The local storage system 108 can be any storage system that can be accessed by computer processes or applications, such as the service connector 104. The local storage system 108 includes one or more storage devices, which may be located on-premises, to store data, including the source files. As an example, the storage devices of the local storage system may include hard disk drives, solid-state drive (SSDs), hybrid drives (sometimes called solid-state hybrid devices (SSHDs), flash drives and any other similar media adapted to store information. These storage devices may be organized as one or more groups of Redundant Array of Independent (or Inexpensive) Disks (RAID) or one or more storage arrays, such as network-attached storage (NAS) or storage array network (SAN) arrays.

The cloud-based storage 110 can be any storage resources on a public cloud, which is provided by a cloud provider, that can be accessed by authorized computer processes or applications, such as the service connector 104. As an example, the cloud-based storage 110 may be cloud storage resources provided by AWS, Microsoft Azure or Google Cloud.

The service 112 can be any service that stores data for its operations. The service 112 may be a storage service that stores data, including the source files. The service 112 can be an email service, an accounting service, a customer relations management (CRM) service or any other service, which maintains data, including files, that can be retrieved by authorized computer processes or applications, such as the service connector 104.

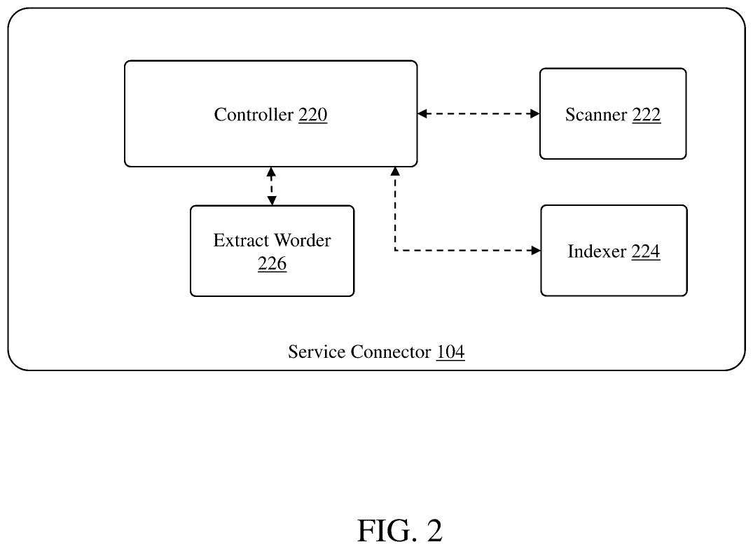

Turning now to FIG. 2, components of the service connector 104 in accordance with an embodiment of the invention are illustrated. As shown in FIG. 2, the service connector 104 includes a controller 220, a scanner 222, an indexer 224 and an extract worker 226. These components of the service connector 104 may be executed in any computing environment, such as a physical computer, a virtual machine or a container. A virtual machine is an emulation of a computer system in the form of a software computer that, like a physical computer, can run an operating system and applications. A virtual machine may be comprised of a set of specification and configuration files and is backed by the physical resources of a physical host computer. An example of such a virtual machine is a virtual machine created using VMware vSphere® solution made commercially available from VMware, Inc of Palo Alto, California. A virtual container is a package that relies on virtual isolation to deploy and run applications that access a shared operating system (OS) kernel. An example of a virtual container is a virtual container created using a Docker engine made available by Docker, Inc.

The controller 220 handles the overall operation of the service connector 104, which may include calling or invoking the scanner 222, the indexer 224 and/or the extract worker 226. The controller 220 may allow a user to interact with the service connector 104 using an application programming interface or other communication methodologies. The controller 220 is also programmed or configured to interact with the external processing service 102 to request services and also to upload or transmit the input ingestion record files of source files.

The scanner 222 operates to selectively scan the storage 106 for the source files of interest, which may be defined by file types in a whitelist or a blacklist, file size and timestamps. These criteria may be provided by a user using the API of the service connector 104. In addition to the file criteria, the scanner 222 may use user-provided credentials to access the one or more local storage systems 108, the one or more cloud-based storages 110 and the one or more services 112 of the storage 106. As an example, the scanner 222 may use the os.scandiro method to selectively scan the storage 106.

The indexer 224 operates to create and maintain an index of the source files found in the storage 106. The file index stores metadata about source files, such as file paths, file identifiers, file sizes, timestamps, and processing status indicators. The file index may be persistently stored anywhere that is accessible by the service connector 104, such as the local storage system 108 or the cloud-based storage 110. The indexer 224 may be implemented using a database management system (e.g., relational database, NoSQL database, embedded database such as the duckDB or SQLite), a file-based index, or an in-memory data structure. The data storage technologies selected may be based on factors such as query performance requirements, data volume, persistence requirements, and deployment environment constraints. For example, an embedded database (e.g., DuckDB or SQLite) may be used when the service connector 104 operates as a self-contained unit without external database dependencies, providing fast query performance and simplified deployment. A relational database (e.g., PostgreSQL, MySQL) may be used when the file index must be shared across multiple service connector instances or when complex querying capabilities are required. A NoSQL database (e.g., MongoDB, or Cassandra) may be used when horizontal scalability across distributed nodes is required or when the index schema needs flexibility. A file-based index may be used for lightweight deployments with small file repositories. An in-memory data structure may be used for temporary indexing operations or when maximum query speed is required and persistence is not necessary.

The extract worker 226 operates to extract metadata and contents from the source files in the file index to create ingestion record files of the source files. As noted above, the metadata and contents of source files may include texts in the source files and descriptions of media in the source files, such as descriptions of graphics in the source files, descriptions of video contents in the source files and transcriptions of audio contents in the source files. As described in more detail below, when the metadata and contents of a source file will result in an ingestion record file that exceeds the file size limit of the external processing service 102, the metadata and contents are split or divided into multiple ingestion record files so that all the contents of the source file can be provided to the external processing service.

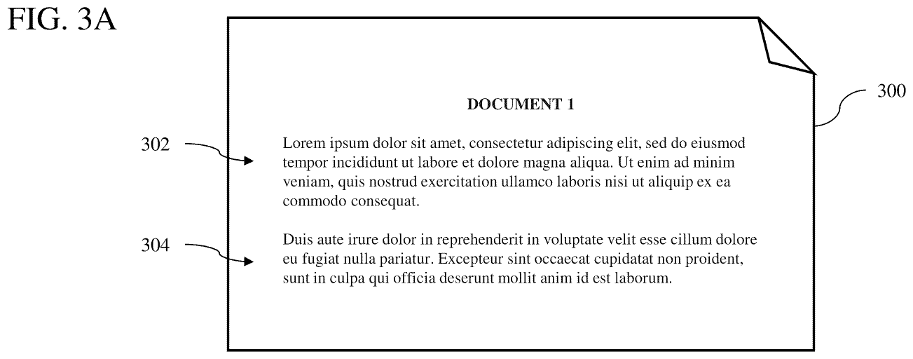

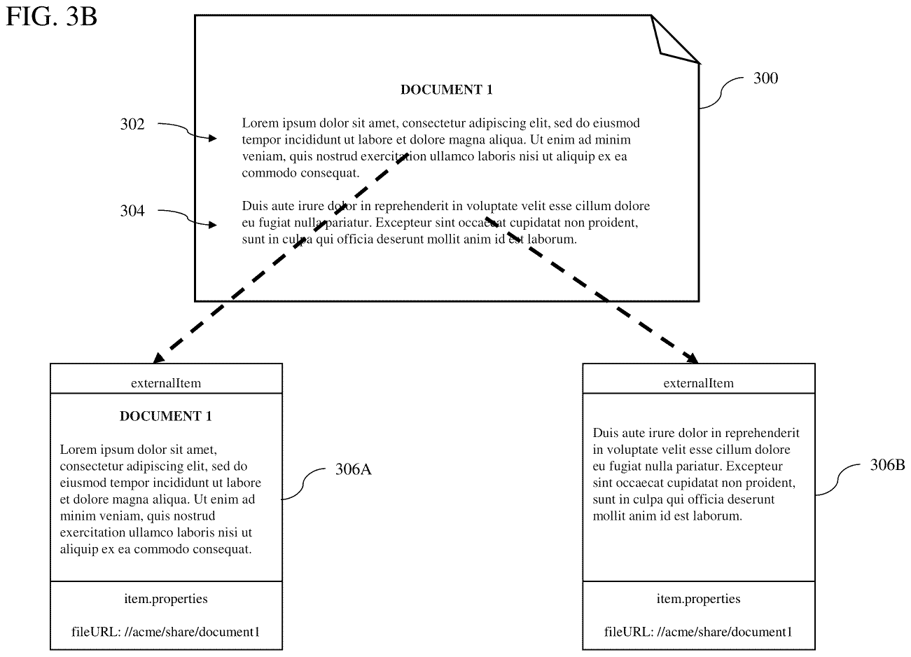

An example of a technique used by the extract worker 226 to create multiple input ingestion record files for a source file using extracted metadata and contents of the source file in accordance with an embodiment of the invention is illustrated in FIGS. 3A and 3B. In this example, as shown in FIG. 3A, the source file is a document 300 and the metadata and contents for the document includes a first text portion 302 and a second text portion 304. Let's assume that the metadata and contents of the document including the first text portion 302 does not exceed the maximum file size, but the metadata and contents of the document including both the first text portion 302 and any of the second text portion 304 does exceed the maximum file size.

Conventionally, only one input ingestion record file would be created from the document 300. However, since all the contents of the metadata and contents would create an input ingestion record file that exceeds the maximum file size, the resulting input ingestion record file would only include the first text portion 302 such that the second text portion 304 is discarded. Thus, the resulting input ingestion record file would be incomplete with respect to the information from the original source file, i.e., the document 300.

In contrast, as illustrated in FIG. 3B, the extract worker 226 of the service connector 104 in accordance with an embodiment would create two input ingestion record files 306A and 306B from the document 300, which may be known as external items. The first input ingestion record file 306A would only include the first text portion 302. The second input ingestion record file 306B would only include the second text portion 304. Both the first and second input ingestion record files 306A and 306B include a source file identifier as part of their item properties, which, in this example, is a universal resource locator (URL). Thus, the complete information contained in the original document 300 can be sent to the external processing service 102 by transmitting the first and second input ingestion record files 306A and 306B.

The metadata and contents of a source file may be split so that complete paragraphs, sentences and/or words are maintained in the multiple input ingestion record file of the source file. In an embodiment, the extract worker 226 may use a paragraph-based division technique, a sentence-based division technique or a word-based division technique to split the metadata and contents of a source file. The paragraph-based division technique looks for the previous paragraph of the contents of a source file when the maximum size limit is reached so that the previous paragraph of the contents is included in one input ingestion record file and the current paragraph of the contents is included in the next input ingestion record file. The sentence-based division technique looks for the previous sentence of the contents of a source file when the maximum size limit is reached so that the previous sentence of the contents is included in one input ingestion record file and the current sentence of the contents is included in the next input ingestion record file. The word-based division technique looks for the previous sentence of the contents of a source file when the maximum size limit is reached so that the previous word of the contents is included in one input ingestion record file and the current sentence of the contents is included in the next input ingestion record file.

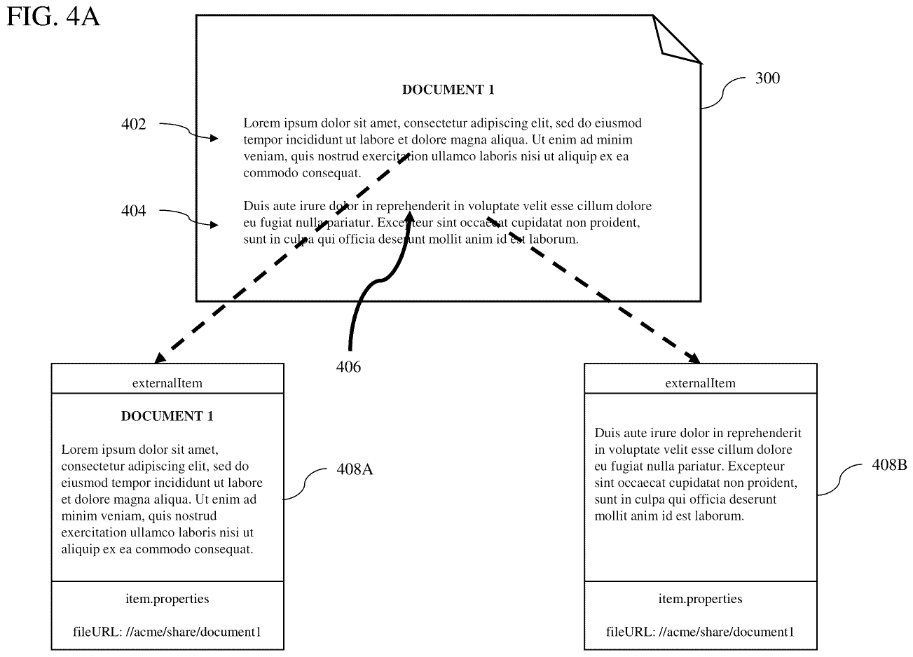

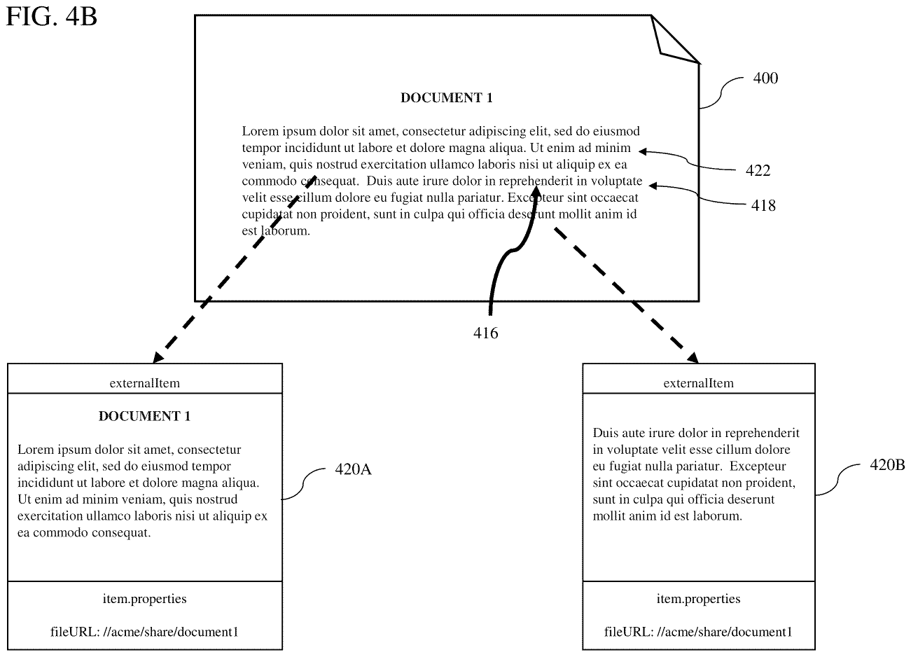

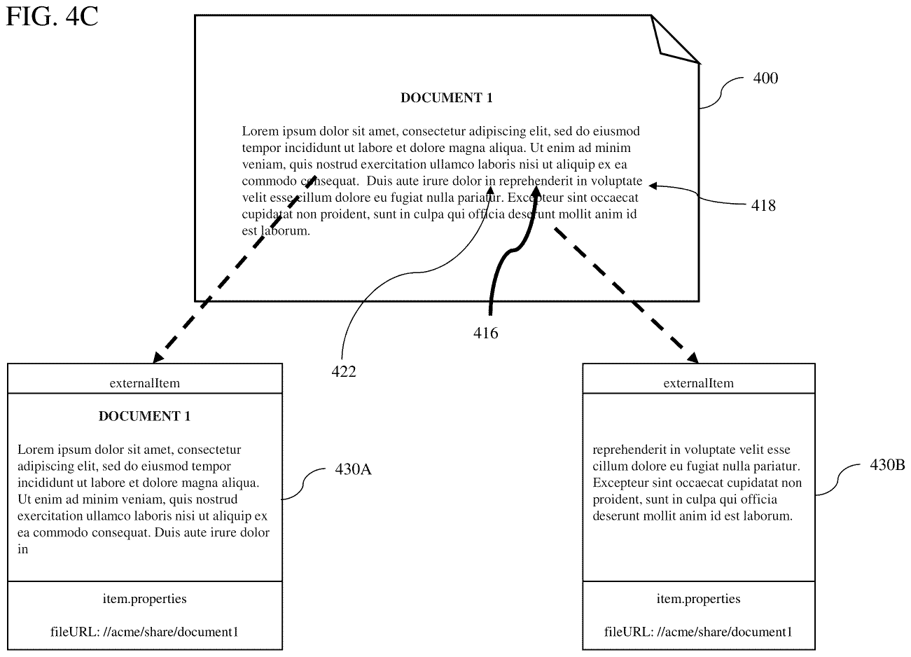

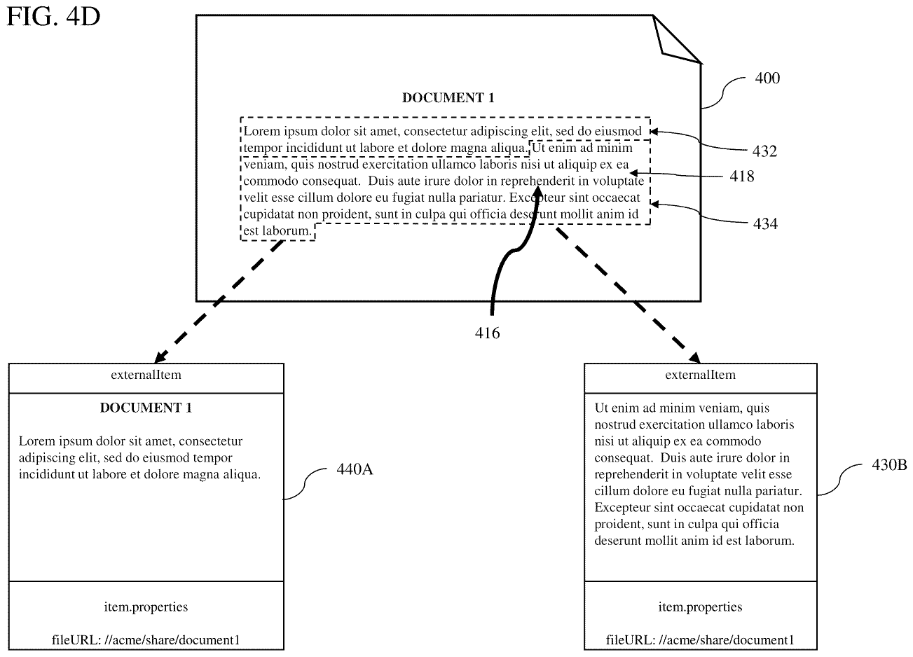

An example of the paragraph-based division technique to split the metadata and contents of a source file into multiple input ingestion record files in accordance with an embodiment of the invention is illustrated in FIG. 4A. In this example, the source file is the document 300 and the metadata and contents for the document includes a first paragraph text portion 402 and a second paragraph text portion 404. Let's assume that, at a location 406 between the letter “h” and the letter “e” of the word “reprehenderit” in the document 300, the maximum size limit for a first input ingestion record file is reached. Then, a search for the previous paragraph in the document 300 from the location 406 is performed by the extract worker 226. For the location 406, the previous paragraph is the first paragraph text portion 402. The metadata and contents of the document 300 is then divided between the first and second paragraph text portions 402 and 404. Thus, in this example, the first paragraph text portion 402 is included in the first input ingestion record file 408A and the second paragraph text portion 404 is included in a second input ingestion record file 408B. This process is further continued if the maximum size limit for the second input ingestion record file 408B is reached. Then, a search for the previous paragraph in the document 300 from that location would be performed to further split the metadata and contents of the document. As illustrated in FIG. 4A, each of the first and second input ingestion record files 408A and 408B includes a source file identifier as part of their item properties, which, in this example, is a URL.

An example of the sentence-based division technique to split the metadata and contents of a source file into multiple input ingestion record files in accordance with an embodiment of the invention is illustrated in FIG. 4B. In this example, the source file is a document 400 and the metadata and contents for the document includes many sentences without paragraph breaks. Let's assume that, at a location 416 between the letter “h” and the letter “e” of the word “reprehenderit” in the sentence 418 of the document 400, the maximum size limit for a first input ingestion record file 420A is reached. Then, a search for the previous sentence in the document 400 from the location 416 is performed by the extract worker 226. For the location 416, the previous sentence is the sentence 422. The metadata and contents of the document are then divided between the sentence 418 and the sentence 422. Thus, in this example, the sentence 422 is included in the first input ingestion record file 420A and the sentence 418 is included in a second input ingestion record file 420B. This process is further continued if the maximum size limit for the second input ingestion record file 420B is reached. Then, a search for the previous sentence in the document 400 from that location would be performed to further split the metadata and contents of the document. As illustrated in FIG. 4B, each of the first and second input ingestion record files 420A and 420B includes a source file identifier as part of their item properties, which, in this example, is a URL.

An example of the word-based division technique to split the metadata and contents of a source file into multiple input ingestion record files in accordance with an embodiment of the invention is illustrated in FIG. 4C. In this example, the source file is the document 400 and the metadata for the document includes many sentences without paragraph breaks. Let's again assume that, at the location 416 between the letter “h” and the letter “e” of the word “reprehenderit” in the sentence 418 of the document 400, the maximum size limit for a first input ingestion record file 430A is reached. Then, a search for the previous word in the document from the location 416 is performed by the extract worker 226. For the location 416, the previous word is the word “in” 424. The metadata and contents of the document is then divided between the word “in” 424 and the word “reprehenderit”. Thus, in this example, the word “in” 424 is included in the first input ingestion record file 430A and the word “reprehenderit” is included in a second input ingestion record file 430B. This process is further continued if the maximum size limit for the second input ingestion record file 430B is reached. Then, a search for the previous word in the document 400 from that location would be performed to further split the metadata and contents of the document. As illustrated in FIG. 4C, each of the first and second input ingestion record files 430A and 430B includes a source file identifier as part of their item properties, which, in this example, is a URL.

The hierarchical fallback mechanism operates dynamically based on the content structure and size constraints. In some embodiments, the sentence-based division technique and/or the word-based division technique may be used as one or more backup techniques when the paragraph-based division technique fails. For example, if the extract worker 226 determines that including the next complete paragraph would exceed the maximum size limit, the paragraph-based division technique “fails” and the extract worker 226 automatically falls back to the sentence-based division technique. Similarly, if including the next complete sentence would exceed the maximum size limit, the sentence-based division technique fails and the extract worker 226 falls back to the word-based division technique. This ensures that content is never truncated mid-word, maintaining minimum semantic integrity even in edge cases where individual paragraphs or sentences are extremely large.

In an embodiment, the extract worker 226 may use a context-based division technique (e.g., a semantic chunking or semantic aware chunking) to split the metadata and contents of a source file into multiple ingestion records. The context-based division technique can be used as an alternative or enhancement to the paragraph-based, sentence-based, and word-based division techniques. The context-based division technique performs semantic analysis of the content to identify semantic text chunks that group sentence by meaning and topical relationship rather than relying solely on structural boundaries (e.g., paragraph breaks, section headings, etc.) or grammatical boundaries (e.g., sentence endings, punctuation marks, etc.). The context-based division technique may be used as an alternative to the hierarchical paragraph-based, sentence-based, and word-based division techniques, or as an enhancement that operations in conjunctions with those techniques to optimize semantic coherence.

The semantic analysis performed by the context-based division technique may employ various natural language processing (NLP) methodologies to identify semantic boundaries in the content. In some embodiments, the extract worker 226 uses embedding-based similarity analysis, wherein sentences or passages are converted into vector representations (i.e., numerical embeddings in a multi-dimensional vector space that capture semantic meaning) using language models (e.g., transformer-based models such as BERT, sentence transformers, or large language models), and semantic similarity between consecutive text segments is computed using distance metrics (e.g., cosine similarity, Euclidean distance).

When the semantic similarity between consecutive segments falls below a threshold value (e.g., indicating a topical shift or semantic discontinuity), a semantic boundary is identified. In other embodiments, the extract worker 226 uses topic modeling techniques (e.g., Latent Dirichlet Allocation (LDA), Non-negative Matrix Factorization (NMF)) to identify topic distributions across text segments, with semantic boundaries identified where topic distributions change significantly.

In still other embodiments, the extract worker 226 uses lexical cohesion analysis (e.g., analyzing word repetition, synonym usage, or co-reference chains) to identify semantically cohesive segments. In yet other embodiments, the extract worker 226 uses discourse structure analysis (e.g., Rhetorical Structure Theory) to identify logical relationships between text segments and establish boundaries at major discourse shifts.

The context-based division technique operates by first segmenting the content into candidate semantic text chunks based on the semantic analysis described above. Each semantic text chunk comprises one or more sentences that exhibit high semantic coherence (i.e., sentences that discuss related concepts, share topical focus, or contribute to a unified idea). For example, in a technical specification document, a semantic text chunk might include all sentences describing a particular system component, even if those sentences span multiple paragraphs or lack clear paragraph structure. In a legal contract, a semantic text chunk might include all sentences related to a specific contractual obligation or term definition. In a research paper, a semantic text chunk might include all sentences describing a particular experimental methodology or result interpretation. When the extract worker 226 determines that including the next semantic text chunk would cause the current ingestion record to exceed the maximum size limit, the extract worker 226 identifies the boundary of the previous semantic text chunk as the division point. The previous semantic text chunk is included in the current ingestion record, and the next semantic text chunk begins a new ingestion record. This ensures that semantically related content remains together within individual ingestion records, preserving contextual relationships that are critical for accurate interpretation by downstream processing systems.

The context-based division technique can be useful for content that lacks clear organizational structure or for applications requiring high semantic fidelity. For Retrieval-Augmented Generation (RAG) systems (e.g., AI systems that retrieve relevant context from a knowledge base to augment generative responses), semantic chunking ensures that retrieved chunks contain complete, contextually coherent information rather than arbitrary fragments, thereby reducing hallucinations and improving response accuracy. For search indexing systems, semantic chunking improves relevance ranking by ensuring that indexed segments represent complete semantic units that can be meaningfully matched to user queries. For question-answering systems, semantic chunking increases the likelihood that relevant answers are contained within single chunks rather than split across multiple chunks, improving retrieval precision. For compliance and governance systems, semantic chunking ensures that policy-relevant content (e.g., all sentences describing data retention requirements) is grouped together, enabling more accurate policy application and audit trail generation.

In embodiments where the context-based division technique is used in conjunction with the hierarchical paragraph-based, sentence-based, and word-based division techniques, the extract worker 226 may first attempt to identify semantic text chunk boundaries. If a semantic text chunk exceeds the maximum size limit (e.g., a single semantic unit is too large to fit within one ingestion record), the extract worker 226 may fall back to the hierarchical techniques, first attempting to divide the oversized semantic chunk at paragraph boundaries, then at sentence boundaries, and finally at word boundaries if necessary. This hybrid approach combines the semantic coherence advantages of context-based division with the guaranteed division capability of the hierarchical techniques, ensuring that content can always be divided to comply with size limitations while maximizing semantic integrity.

An example of the context-based division technique to split the metadata and contents of a source file into multiple ingestion record files in accordance with an embodiment of the invention is illustrated in FIG. 4D. In this example, the source file is the document 400 and the metadata and contents for the document includes many sentences without paragraph breaks. Let's again assume that, at the location 416 between the letter “h” and the letter “e” of the word “reprehenderit” in the sentence 418 of the document 400, the maximum size limit for a first input ingestion record file 440A is reached. Then, a search for the previous semantic text chunk from the location 416 is performed by the extract worker 226. In this example, the previous semantic text chunk for the document 400 is the semantic text chunk 432. The metadata and contents of the document 400 is then divided between the previous semantic text chunk 432 and the next semantic text chunk 434. Thus, in this example, the semantic text chunk 432 is included in the first ingestion record file 440A and the semantic text chunk 434 is included in a second ingestion record file 440B. This process is further continued if the maximum size limit for the second ingestion record file 440B is reached. Then, a search for the semantic text chunk in the document from that location would be performed to further split the metadata and contents of the document. As illustrated in FIG. 4D, each of the first and second ingestion record files 440A and 440B includes a source file identifier as part of their item properties, which, in this example, is a URL.

In operation, a user may interact with the service connector 104 using, for example, it's API. Using the API, the user may add a new share or a logical storage unit, which may be a volume or a directory, by making a request, e.g., a POST request. This new share may include the share path (which may use a universal naming convention (UNC), e.g., //acme/share), credentials (e.g., username and password) and rules for that share (e.g., schedule, exclude certain file types, exclude certain file sizes (using minimum and/or maximum size values), range of timestamps). After the new share has been added, an extracting process may be initiated.

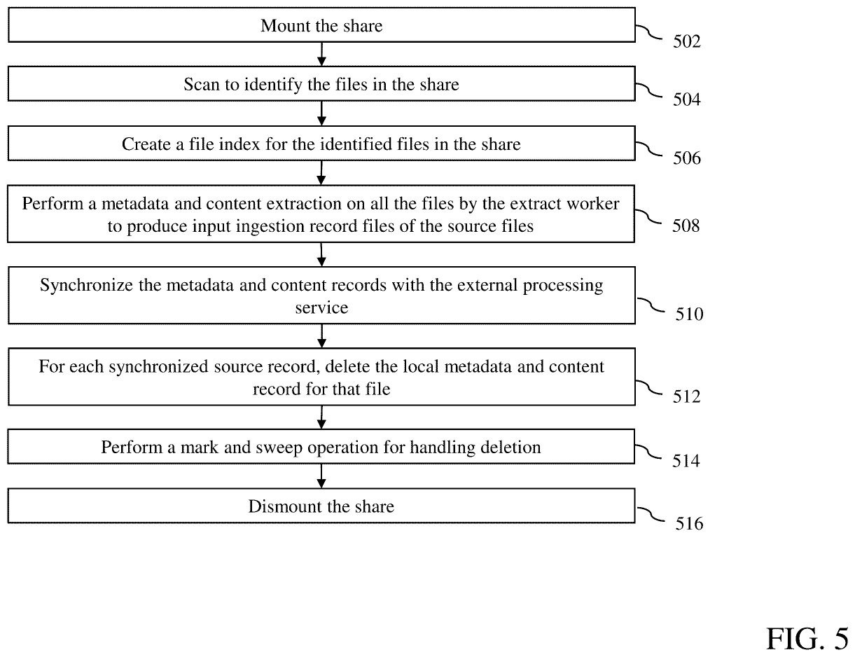

The extracting process in accordance with an embodiment of the invention is described with reference to a flow diagram of FIG. 5. The extracting process may be initiated or started when it is invoked by the controller 220 of the service connector 104. The extracting process begins at step 502, where the share is mounted. Next, at step 504, the share is scanned to identify the files in the share. As an example, the os.scandir can be used to scan the share.

Next, at step 506, a file index is created for the identified files in the share. As an example, duckDB may be used to create the file index, which may be persisted anywhere in the storage 106 or any other storage accessible by the service connector 104. Next, at step 508, a metadata and content extraction is performed on all the files by the extract worker 226 to produce input ingestion record files of the source files, which may include multiple related ingestion record files for the complex and/or very large source files. The metadata and content extraction operation includes crawling through a source file and extracting metadata from the source file in the form of texts.

Next, at step 510, the metadata and content records are synchronized with the external processing service 102, which involves submitting or transmitting the metadata and content records for new and updated source files. The metadata and content records of updated source files are included since the contents of the updated source files may have been added or deleted since the previous synchronization. The metadata and content records may be submitted to the external processing service 102 in any suitable manner, including using an API provided by the external processing service.

Next, at step 512, for each synchronized source record, the local content metadata and content record for that file is deleted. This is an optional step to reduce the amount of data maintained in the service connector 104 as the content has been transmitted to the external processing service 102. The file index entry for the source file is retained to track processing status and enable incremental synchronization, but the extracted content itself (which could be large) is removed to conserve local storage resources.

Next, at step 514, a mark and sweep operation for handling deletion is performed to remove items no longer in the share from the external processing service 102. This step is performed to ensure that only current source files are being synchronized with the external processing service 102. For example, if a source file was previously synchronized but has since been deleted in the share, the mark and sweep operation identifies the corresponding ingestion records in the external processing service 102 and removes them. Next, at step 516, the share is dismounted, which ensures that the data in the storage 106 are secure.

In some embodiments, the service connector 104 employs a method of combining parallel computing strategies with the document extraction process in order to address the limitations of single thread processes associated with extraction and conversion steps. The use of this technology within the service connector allows these compute expensive processes to utilize all available central processing unit (CPU) resources at runtime, dramatically reducing the time taken to perform these operations, which may result in greater than 580% performance improvements to sequential processing. As most extract tasks are based on using Python for data manipulation, they are subject to the Python Global Interpreter Lock. The Python Global Interpreter Lock (GIL) is a mutex that allows only one thread to control the Python interpreter at any given time. This means that even in a multi-threaded architecture, only one thread can execute Python bytecode at a time. By applying parallel compute to the crawling and extraction tasks this limitation is removed.

Combining the above approach of parallel computing with a distributed computing implementation provides further performance enhancements through the ability to scale-out these resource intensive tasks across multiple computing nodes. In a distributed computing embodiment, the service connector 104 includes a worker manager component that coordinates a pool of extract workers 226, which may be deployed on the same computing node (for parallel processing) or distributed across multiple computing nodes (for distributed processing). The worker manager delegates extraction tasks to available extract workers 226 using a task distribution algorithm, such as a round-robin (wherein tasks are assigned sequentially to each worker in rotation), load-based delegation (wherein tasks are assigned to the worker with the lowest current load), or priority-based delegation (wherein tasks are assigned based on file size, file type, or other priority criteria). The distributed computing architecture enables horizontal scaling, wherein additional extract workers 226 can be added to the pool to increase overall extraction throughput. In some embodiments, the number of extract workers 226 in the pool may be dynamically scaled based on factors such as computational resource availability, power costs, processing demand, or time-of-day considerations.

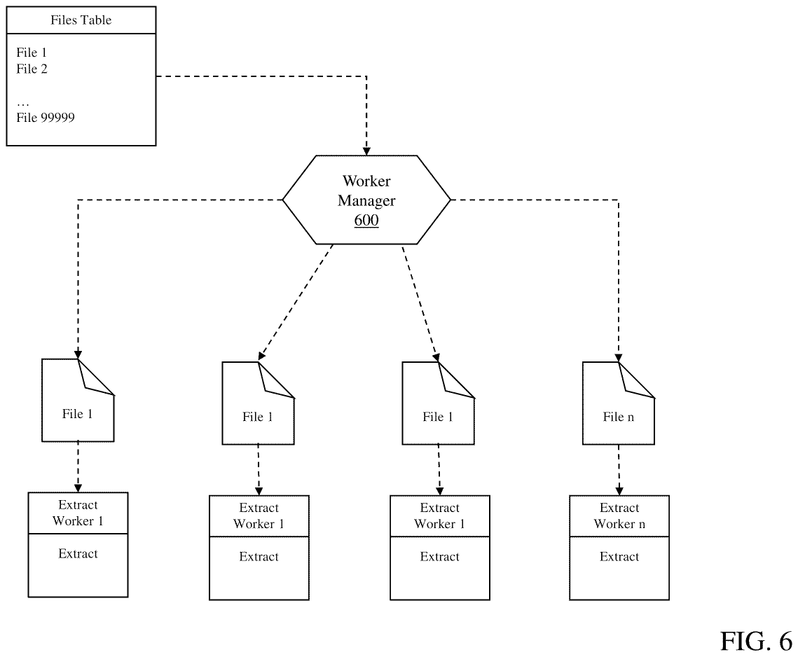

FIG. 6 illustrates a distributed computing process that may be employed by the service connector 104 in accordance with an embodiment of the invention. As shown in FIG. 6, a worker manager 600 in the service connector 104 is used to distribute source files to be processed in the file index or table to the pool of extract workers 1 to n in a round-robin fashion or any other task distribution methodology. Thus, the source files are each delegated to the workers to execute the extraction operations to produce ingestion record files of the source files.

Due to the dynamic nature of the extract workers pool, it becomes a possibility to dynamically scale the number of extract workers in line with power or compute cost changes. For example, when the cost of power and/or compute is 50%, the number of extract workers being used can be doubled to decrease the extract duration phase.

This cost-based scaling may be implemented by monitoring real-time or time-of-day pricing data from power utilities or cloud service providers (e.g., AWS EC2 spot pricing, Azure spot virtual machines, Google Cloud preemptible instances) and adjusting the worker pool size according to predefined cost thresholds or cost optimization algorithms. For example, during off-peak electricity hours (e.g., between 10 PM and 6 AM) when power costs are typically 40-60% lower than peak rates, or during periods of reduced cloud computing demand resulting in lower spot instance pricing, the worker manager 600 may scale from a baseline number of workers (e.g., n workers) to an increased number (e.g., 2n workers or more) to accelerate processing while maintaining cost efficiency.

In other embodiments, the number of extract workers is scaled based on processing demand metrics that quantify the workload requiring processing. Processing demand may be measured by various metrics, including: (1) backlog size (i.e., the number of source files in the file index awaiting extraction, measured as a count or as an aggregate size in bytes, gigabytes, or terabytes); (2) queue depth (i.e., the number of extraction tasks pending assignment to workers); (3) average wait time (i.e., the time duration between when a source file is added to the index and when extraction begins); or (4) processing rate differential (i.e., the difference between the rate at which new source files are being added to the index and the rate at which files are being processed).

For example, if the backlog size exceeds a threshold value (e.g., 10,000 files or 1 terabyte of aggregate content), the worker manager 600 may increase the number of extract workers from a baseline number (e.g., 4 workers) to an elevated number (e.g., 16 workers) to accelerate backlog processing.

In still other embodiments, the number of extract workers is scaled based on available computational resources, which may be monitored in real-time or at periodic intervals. Available computational resources may include: (1) available CPU capacity, measured as percentage of idle CPU cores, CPU utilization percentage, or CPU load average; (2) available memory, measured as free RAM in gigabytes or as percentage of total memory not currently allocated; (3) available network bandwidth, measured as unused network capacity in megabits per second (Mbps) or gigabits per second (Gbps); or (4) available storage I/O capacity, measured as disk read/write operations per second (IOPS) or disk queue length.

For example, if CPU utilization is below 50% (indicating substantial available capacity), the worker manager 600 may increase the number of extract workers to utilize the available capacity. Conversely, if CPU utilization exceeds 90% (indicating resource saturation), the worker manager 600 may decrease the number of extract workers to prevent system overload and maintain system stability.

In yet other embodiments, the worker manager 600 implements hybrid scaling that combines multiple factors, such as cost, demand, and resource availability, using weighted scoring, decision-tree logic, or optimization algorithms (e.g., linear programming, constraint satisfaction, reinforcement learning models) to determine optimal worker pool size. For example, during off-peak hours (low cost) with high backlog (high demand) and available CPU capacity above 60%, the worker manager 600 may scale to maximum worker count; during peak hours (high cost) with low backlog, the worker manager 600 may scale to minimum worker count to minimize operational costs; during peak hours with high backlog but limited available resources (e.g., CPU utilization above 85%), the worker manager 600 may scale to a moderate worker count to balance demand against resource constraints and cost considerations.

The dynamic scaling capability enables the service connector 104 to optimize competing objectives, including minimizing total processing time, minimizing operational costs, maximizing resource utilization efficiency, maintaining system stability, and meeting service level objectives or agreements (e.g., completing extraction within specified time windows, maintaining minimum throughput rates).

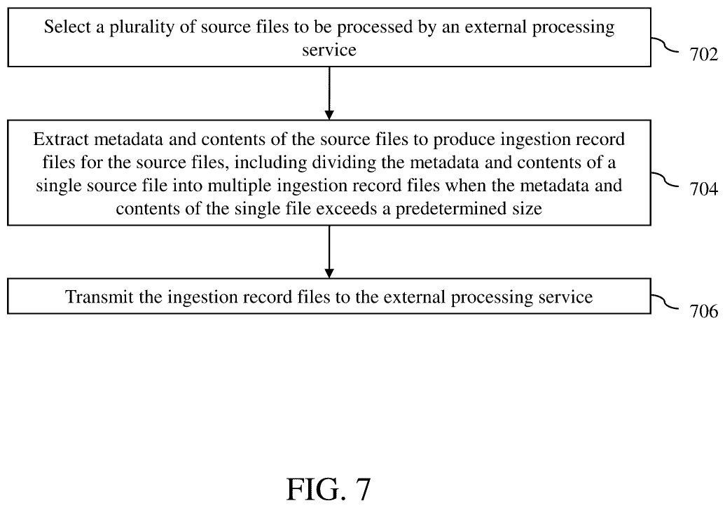

Turning now to FIG. 7, a process flow diagram of a method executed by one or more processors in accordance with an embodiment of the disclosure is shown. At block 702, a plurality of source files to be processed by an external processing service is selected. The selection of source files may be based on various selection criteria, including but not limited to: (1) file type criteria (e.g., selecting files with specific extensions such as.docx, .pdf, .pptx, .xlsx, or MIME types such as text/plain, application/pdf, video/mp4); (2) file size criteria (e.g., selecting files within a size range such as between 1 megabyte and 100 megabytes, or selecting files above a minimum size threshold such as 10 kilobytes to exclude empty or trivial files); (3) temporal criteria (e.g., selecting files created or modified within a time range, such as files modified within the last 30 days, or files created after a specific timestamp); (4) location criteria (e.g., selecting files from specific directories, volumes, shares, or storage paths, such as //fileserver/engineering/docs or/mnt/storage/legal); (5) metadata criteria (e.g., selecting files with specific attributes, tags, classifications, or ownership); or (6) content criteria (e.g., selecting files containing specific keywords, topics, or data patterns identified through preliminary scanning or indexing). The selection may be performed by the scanner 222 based on user-defined rules provided via the API of the service connector 104, or may be performed automatically based on predefined policies, schedules, or triggers (e.g., selecting newly added files, selecting files that have changed since the last synchronization, or selecting files in response to specific events such as file system notifications or webhook callbacks).

At block 704, metadata and contents of the files are extracted to produce ingestion record files for the source files. The extraction of metadata and contents can involve multiple sub-operations, including: (1) accessing the source file from the storage system using appropriate access methods (e.g., file system APIs, network protocols such as SMB/CIFS or NFS, cloud storage APIs such as S3 or Azure Blob Storage APIs); (2) determining the file type and format (e.g., by examining file extensions, MIME types, or magic numbers in file headers); (3) parsing the file structure according to the file format specification (e.g., parsing XML structure for.docx files, parsing PDF object structure for .pdf files, parsing binary structures for proprietary formats); (4) extracting textual content from the file, which may include direct text extraction for text-based formats (e.g., .txt, .csv, .json files), optical character recognition (OCR) for image-based content (e.g., scanned documents, images embedded in PDFs), speech-to-text transcription for audio content (e.g., .mp3, .wav, .m4a files), or video analysis and transcription for video content (e.g., .mp4, .avi, .mov files); (5) extracting metadata from the file, including intrinsic metadata (e.g., author, creation date, modification date, title, subject, keywords embedded in document properties) and extrinsic metadata (e.g., file path, file size, file permissions, storage location); and (6) converting the extracted content into a standardized textual representation suitable for ingestion by the external processing service (e.g., plain text, UTF-8 encoded text, or structured formats such as JSON or XML).

The extraction of the metadata and contents of the source files includes dividing the metadata and contents of a single source file into multiple ingestion records when the metadata and contents of the single file exceeds a predetermined size. The predetermined size may be specified by the external processing service (e.g., 3.8 megabytes for Microsoft Graph external items, or other size limits imposed by different external processing services), or may be configured by the user or administrator based on network transmission constraints, processing timeout limits, or other operational considerations.

The division process employs semantic-aware chunking techniques to identify optimal division points that preserve semantic coherence and contextual meaning. Specifically, the division process may employ: (1) a hierarchical approach that first attempts paragraph-based division (identifying paragraph boundaries as division points to preserve complete topical units), falls back to sentence-based division if paragraph-based division would exceed size limits (identifying sentence boundaries to preserve grammatically complete units), and finally falls back to word-based division if sentence-based division would exceed size limits (identifying word boundaries to ensure minimum lexical integrity); or (2) a context-based division approach that performs semantic analysis using natural language processing techniques (e.g., embedding-based similarity analysis, topic modeling, lexical cohesion analysis, or discourse structure analysis) to identify semantic text chunks representing topically coherent segments, and divides content at semantic chunk boundaries where topical shifts or semantic discontinuities occur.

The division process can include several technical considerations and trade-offs. First, the chunk size must balance competing objectives: larger chunks preserve more context and reduce the total number of ingestion records (reducing API call overhead and simplifying downstream processing), but increase the risk of exceeding size limits and may reduce granularity for retrieval operations; smaller chunks ensure compliance with size limits and provide finer retrieval granularity, but may fragment context and increase the total number of ingestion records (increasing API call overhead, transmission time, and storage requirements in the external processing service). Second, the choice of division technique involves trade-offs: paragraph-based division maximizes semantic coherence for well-structured documents with clear paragraph organization, but may be ineffective for documents lacking paragraph structure (e.g., continuous text, transcripts, or poorly formatted documents); sentence-based division provides grammatical completeness and works for documents without paragraph structure, but may create very small chunks if sentences are short or very large chunks if sentences are long (e.g., legal documents with extensive compound sentences); word-based division guarantees that content can always be divided to fit within size limits, but provides minimal semantic coherence and may split semantically related content; context-based division maximizes semantic coherence by grouping topically related content regardless of structural boundaries, but requires additional computational resources for semantic analysis (e.g., generating embeddings, computing similarity scores, or performing topic modeling) and may introduce processing latency. Third, the division process must handle edge cases, such as: (a) source files smaller than the predetermined size (no division required, single ingestion record created); (b) source files where a single paragraph, sentence, or semantic chunk exceeds the predetermined size (requiring fallback to the next division technique in the hierarchy); (c) source files with minimal or no textual content (e.g., pure image files, binary files) where extracted descriptions or metadata alone constitute the content; or (d) source files with mixed content types (e.g., documents containing text, images, tables, and embedded media) requiring coordinated extraction and division across content types.

Each ingestion record created during the division process includes: (1) a portion of the extracted content (i.e., a chunk of text corresponding to one or more paragraphs, sentences, semantic text chunks, or words, depending on the division technique employed); (2) a reference to the originating source file (e.g., a file identifier such as a UUID, a file path such as a UNC path or file system path, a URL pointing to the source file location, or a combination of multiple reference types to ensure robust association even if the file is moved or renamed); (3) sequencing metadata indicating the position of the chunk within the complete set of chunks for the source file (e.g., chunk index such as “1 of 5”, “2 of 5”, etc., enabling the external processing service to determine ordering and completeness); (4) metadata about the division technique employed (e.g., indicating whether the chunk was created using paragraph-based, sentence-based, word-based, or context-based division, and identifying the specific boundary type such as “paragraph boundary after paragraph 45” or “semantic boundary at topic shift”); and (5) standard metadata from the source file (e.g., file name, file size, creation timestamp, modification timestamp, author, file type, and any other relevant metadata extracted from the source file or file system). The inclusion of the source file reference in each ingestion record is critical for maintaining compatibility with upstream and downstream processes of the external processing service, enabling the service to: (a) associate all ingestion records with their originating source file for search result presentation (e.g., displaying the source document name and location when returning search results derived from any chunk); (b) apply compliance policies to the complete document rather than individual chunks (e.g., applying data retention policies, access controls, or classification labels to all chunks associated with a source file); (c) enable user navigation from processed content back to the source file (e.g., providing a link from a search result or AI-generated response back to the original document); and (d) support content reassembly or aggregation operations if needed (e.g., reconstructing the complete document content from multiple chunks for full-document analysis or display).

At block 706, the ingestion record files are transmitted to the external processing service. The transmission may be performed using various communication methods and protocols, including: (1) RESTful API calls (e.g., HTTP POST or PUT requests to API endpoints provided by the external processing service, with ingestion records transmitted as JSON payloads, XML payloads, or multipart form data); (2) GraphQL mutations (e.g., for services that provide GraphQL interfaces such as Microsoft Graph); (3) batch upload operations (e.g., transmitting multiple ingestion records in a single API call to reduce network round-trips and improve throughput, subject to batch size limits imposed by the external processing service); (4) streaming protocols (e.g., transmitting ingestion records as a continuous stream using protocols such as gRPC, WebSockets, or Server-Sent Events); or (5) message queue systems (e.g., publishing ingestion records to message queues such as Apache Kafka, RabbitMQ, or cloud-based queue services such as AWS SQS or Azure Service Bus, with the external processing service consuming records from the queue).

The transmission process may also include error handling and retry logic to ensure reliable delivery, such as: (a) detecting transmission failures (e.g., network errors, timeouts, HTTP error status codes such as 500 Internal Server Error or 503 Service Unavailable); (b) implementing retry strategies with exponential backoff (e.g., retrying failed transmissions after increasing delays such as 1 second, 2 seconds, 4 seconds, 8 seconds, up to a maximum retry count or maximum delay); (c) handling rate limiting imposed by the external processing service (e.g., respecting HTTP 429 Too Many Requests responses and implementing throttling to stay within rate limits such as requests per second or requests per minute); and (d) maintaining transmission state to enable resumption after failures (e.g., tracking which ingestion records have been successfully transmitted and which remain pending, enabling the service connector to resume transmission from the point of failure rather than retransmitting all records). The transmission process may also include optimization techniques such as: (i) parallel transmission using multiple concurrent connections or threads to increase throughput (subject to rate limits and connection limits imposed by the external processing service); (ii) compression of ingestion record payloads (e.g., using gzip, deflate, or broth compression) to reduce transmission time and bandwidth consumption; (iii) connection pooling and keep-alive to reuse network connections across multiple API calls, reducing connection establishment overhead; or (iv) prioritization of transmission based on file importance, recency, or other criteria (e.g., transmitting recently modified files first, or transmitting smaller files before larger files to provide faster initial results).

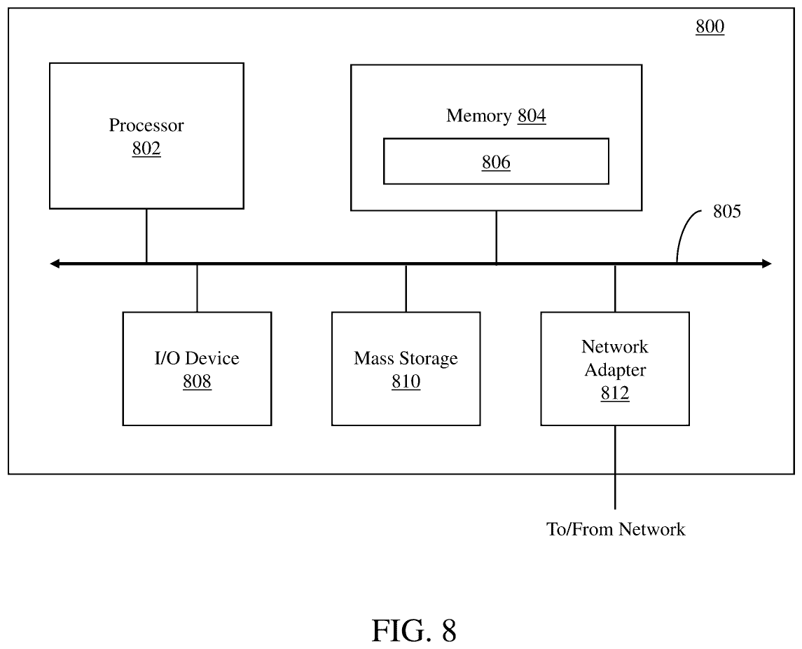

FIG. 8 is a high-level block diagram showing an example of the architecture of a processing system 800 in accordance with an embodiment of the invention, in which executable instructions for operations as described above can be implemented. The processing system 800 can represent one or more components in the computing environment 100 described herein. Note that certain standard and well-known components which are not germane to the present invention are not shown in FIG. 8.

The processing system 800 includes one or more processors 802 and memory 804, coupled to a bus system 805. The bus system 805 shown in FIG. 8 is an abstraction that represents any one or more separate physical buses and/or point-to-point connections, connected by appropriate bridges, adapters and/or controllers. The bus system 805, therefore, may include, for example, a system bus, a Peripheral Component Interconnect (PCI) bus, a HyperTransport or industry standard architecture (ISA) bus, a small computer system interface (SCSI) bus, a universal serial bus (USB), or an Institute of Electrical and Electronics Engineers (IEEE) standard 1394 bus (sometimes referred to as “Firewire”).

The processors 802 are the central processing units (CPUs) of the processing system 800 and, thus, control its overall operation. In certain aspects, the processors 802 accomplish this by executing programmable instructions stored in the memory 804. Each processor 802 may be, or may include, one or more programmable general-purpose or special-purpose microprocessors, digital signal processors (DSPs), programmable controllers, application specific integrated circuits (ASICs), programmable logic devices (PLDs), or the like, or a combination of such devices.

The memory 804 represents any form of random-access memory (RAM), read-only memory (ROM), flash memory, or the like, or a combination of such devices. The memory 804 includes the main memory of the processing system 800. Instructions 806 which implement techniques introduced above may reside in and may be executed by the processors 802 from the memory 804. For example, the instructions 806 may include code used for executing at least some of steps of methods described herein, as well running various applications/processes running in the computing environment 100.

Also connected to the processors 802 through the bus system 805 are one or more internal mass storage devices 810, and a network adapter 812. The internal mass storage devices 810 may be or may include any conventional medium for storing large volumes of data in a non-volatile manner, such as one or more magnetic or optical based disks. The network adapter 812 provides the processing system 800 with the ability to communicate with remote devices (e.g., storage servers) over a network and may be, for example, an Ethernet adapter, a Fibre Connector (FC) adapter, or the like. The processing system 800 also includes one or more input/output (I/O) devices 808 coupled to the bus system 805. The I/O devices 808 may include, for example, a display device, a keyboard, a mouse, etc.

Note that references throughout this specification to “one aspect” or “an aspect” mean that a particular feature, structure or characteristic described in connection with the aspect is included in at least one aspect of the present disclosure. Therefore, it is emphasized and should be appreciated that two or more references to “an aspect” or “one aspect” or “an alternative aspect” in various portions of this specification are not necessarily all referring to the same aspect. Furthermore, the particular features, structures or characteristics being referred to may be combined as suitable in one or more aspects of the present disclosure, as will be recognized by those of ordinary skill in the art.

Similarly, reference throughout this specification to “one embodiment,” “an embodiment,” or similar language means that a particular feature, structure, or characteristic described in connection with the indicated embodiment is included in at least one embodiment of the present invention. Thus, the phrases “in one embodiment,” “in an embodiment,” and similar language throughout this specification may, but do not necessarily, all refer to the same embodiment.

While the present disclosure is described above with respect to what is currently considered its preferred aspects, it is to be understood that the disclosure is not limited to that described above. To the contrary, the disclosure is intended to cover various modifications and equivalent arrangements within the spirit and scope of the appended claims.

What is claimed is:

1. A method executed by one or more processors, the method comprising:
selecting a plurality of source files to be processed by an external processing service;
extracting metadata and contents of the source files to produce ingestion record files for the source files, including dividing the metadata and contents of a single source file into multiple ingestion record files when the metadata and contents of the single file exceeds a predetermined size; and
transmitting the ingestion record files to the external processing service.

2. The method of claim 1, wherein dividing the metadata and contents of the single source file into the multiple ingestion record files includes applying a paragraph-based division technique to split the metadata and contents of the single source file between paragraphs of the metadata and contents of the single source file into the multiple ingestion record files.

3. The method of claim 1, wherein dividing the metadata and contents of the single source file into the multiple ingestion record files includes applying a sentence-based division technique to split the metadata and contents of the single source file between sentences of the metadata and contents of the single source file into the multiple ingestion record files.

4. The method of claim 1, wherein dividing the metadata and contents of the single source file into the multiple ingestion record files includes applying a word-based division technique to split the metadata and contents of the single source file between words of the metadata and contents of the single source file into the multiple ingestion record files.

5. The method of claim 1, wherein dividing the metadata and contents of the single source file into the multiple ingestion record files includes applying a context-based division technique to split the metadata and contents of the single source file based on semantic text chunks produced from a context-aware text splitting process.

6. The method of claim 1, wherein each of the multiple ingestion record files of the single source file includes a source file identifier.

7. The method of claim 1, further comprising accessing a target logical storage unit of a storage system by a connector that is configured to connect with the external processing service, wherein the target logical storage unit includes the source files.

8. The method of claim 1, wherein the target logical storage unit is a volume or a directory in the storage system.

9. The method of claim 1, wherein the external processing service includes a generative artificial intelligence (AI) chatbot service.

10. The method of claim 1, wherein the metadata and contents of the source files include texts in the source files and descriptions of media contents in the source files.

11. A non-transitory computer-readable storage medium containing program instructions, wherein execution of the program instructions by one or more processors cause one or more computers to:
select a plurality of source files to be processed by an external processing service;
extract metadata and contents of the source files to produce ingestion record files for the source files, including dividing the metadata and contents of a single source file into multiple ingestion record files when the metadata and contents of the single file exceeds a predetermined size; and
transmit the ingestion record files to the external processing service.

12. The non-transitory computer-readable storage medium of claim 11, wherein dividing the metadata and contents of the single source file comprises:
attempting to identify a paragraph boundary in the metadata and contents at a position before the predetermined size;
if no paragraph boundary is identified at a position before the predetermined size, attempting to identify a sentence boundary in the metadata and contents at a position before the predetermined size; and
if no sentence boundary is identified at a position before the predetermined size, identifying a word boundary in the metadata and contents at a position before the predetermined size.

13. The non-transitory computer-readable storage medium of claim 11, wherein the multiple ingestion record files collectively preserve complete content of the single source file without discarding any portion of the metadata and contents.

14. The non-transitory computer-readable storage medium of claim 11, wherein the program instructions further cause the one or more computers to:
distribute extraction tasks for the plurality of source files across a pool of processing workers executing in parallel;
monitor at least one of: power cost, computational resource availability, or processing demand; and
dynamically adjust a number of processing workers in the pool based on the monitored factor to optimize energy consumption while maintaining processing throughput.

15. The non-transitory computer-readable storage medium of claim 14, wherein dynamically adjusting the number of processing workers comprises:
determining a backlog size representing a number of source files awaiting processing;
when the backlog size exceeds a first threshold, increasing the number of processing workers to reduce processing time; and
when the backlog size falls below a second threshold, decreasing the number of processing workers to conserve computational resources.

16. The non-transitory computer-readable storage medium of claim 11, wherein each of the multiple ingestion record files of the single source file includes one or more of the following:
a source file identifier that includes a universally unique identifier (UUID) that remain valid if the single source file is moved or renamed, a file path indicating a current storage location of the single source file, and/or a timestamp indicating when the metadata and contents were extracted from the single source file.

17. The non-transitory computer-readable storage medium of claim 11, wherein the steps further comprise access a target logical storage unit of a storage system by a connector that is configured to connect with the external processing service, wherein the target logical storage unit includes the source files.

18. The non-transitory computer-readable storage medium of claim 11, wherein the external processing service includes a retrieve-augmented generation (RAG) system.

19. The non-transitory computer-readable storage medium of claim 11, wherein the metadata and contents of the source files include texts in the source files and descriptions of media contents in the source files.

20. A system comprising:
memory; and
at least one processor configured to:
extract metadata and contents from a source file to be processed by an external processing service that imposes a size limitation on input files;
identify, in response to determining that the extracted metadata and context exceed the size limitation, a semantic boundary in the extracted metadata and contents;
divide the extracted metadata and contents into a plurality of ingestion records based on the identified semantic boundary, wherein each ingestion record does not exceed the size limitation;
preserve, in each of the plurality of ingestion records, a reference to the source file; and
transmit the plurality of ingestion records to the external processing service.
